(19) United States
(12) Patent Application Publication
(10) Pub. No.: US 2014/0362564 A1
(43) Pub. Date: Dec. 11, 2014

(54) Solar-Powered Bollard Lamp Devices

(71) Applicant: Nathan Giblett, Austin, TX (US)

(72) Inventor: Nathan Giblett, Austin, TX (US)

(21) Appl. No.: 14/187,388

(22) Filed: Feb. 24, 2014

(30) Foreign Application Priority Data
Jun. 11, 2013 (AU) 2013206264

(51) Int. Cl. F21S 9/03

(52) U.S. Cl. CPC F21S 9/035
USPC 362/183

(57) ABSTRACT

Described herein is technology relevant to light emitting devices, and components for light emitting devices. Embodiments are primarily described by reference to a bollard lamp. However, it will be appreciated that the technology has wider application.

### FIELD OF THE INVENTION

The present invention relates to a light emitting device, and components for a light emitting device. Embodiments of the invention have been particularly developed to provide a solar-powered bollard lamp. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Bollard lamps are widely used, for example in the context of outdoor spaces and passages. Although various attempts have been made to allow such devices to operate without connection to external power (for instance via solar panels), those attempts have fallen short of resulting in an end-product that is applicable across a range of implementation environments.

There is a need in the art for improved light emitting devices, and components for such devices.

### SUMMARY OF THE INVENTION

It is an object of the present invention to overcome or ameliorate at least one of the disadvantages of the prior art, or to provide a useful alternative.

One embodiment provides a bollard light including:

a substantially prismatic body having a base, a top, and three or more vertically extending elongate sidewalls extending between the base and the top;

at least one light emitting component supported by the body; and

a plurality of solar panels supported by the body, wherein the plurality of solar panels generate power for consumption by the at least one light emitting component, and wherein at least 60% of each sidewall is covered by solar panel.

One embodiment provides a bollard light including:

a vertically extending extruded member of substantially continuous cross section;

wherein the extruded member includes at least three sidewalls collectively defining a central core;

wherein each sidewall has a pair of extending protrusions along its vertically extending edges, the protrusions of a given sidewall collectively defining a channel bounded by inner faces of the protrusions and an outer face of the sidewall, the channel being configured for receiving a solar panel and a LED mounting assembly; and

wherein each channel is additional configured to optionally support a covering member in place of the LED mounting assembly, such that when assembled the bollard light supports a number of LED mounting assemblies less than the number of sidewalls.

One embodiment provides a bollard lamp including:

a base member;

a plurality of planar sidewalls extending vertically from the base, each sidewall having an outer surface and an inner surface, a central core being defined intermediate the inner surfaces;

a plurality of solar panels, each panel having an outward-facing functional surface and an inward facing surface, each inner facing surface being abuttingly engaged with a respective one of the sidewall outer surfaces;

a top cap having a plurality of rod receiving formations, wherein the top cap abuttingly engaged against respective top edges of the plurality of sidewalls, and the red receiving formations are contained within the central core;

a plurality of rods, each being mounted to at its distal and to one of the rod receiving formations and at its proximal end to the base member;

wherein the base member includes a plurality of apertures thereby to facilitate external access to one or more fixing members used to securely attach the rods to the base member.

One embodiment provides a bollard light including:

a plurality of vertically-mounted solar panels, each panel having an outward-facing functional surface and an inward facing surface;

for each solar panel, a bollard sidewall having an outer surface and an inner surface, wherein the outer surface of the bollard sidewall is positioned adjacent the inward facing surface of the solar panel;

a plurality of heat dissipation protrusions formed on the inner surface of each bollard sidewall, the heat dissipation protrusions extending into a central core defined by space between the sidewalls, such that heat accumulating at the solar panels is dissipated via the inner surface and the heat dissipation protrusions.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 provides a side view of a bollard lamp according to one embodiment.

FIG. 2 provides a perspective view of the bollard lamp.

FIG. 3 provides a cross-sectional view of an extruded component of the bollard lamp.

FIG. 4 provides a perspective view of the extruded component.

FIG. 5 provides a perspective view of the extruded component, in conjunction with other components.

FIG. 6 provides an end view of a retaining formation shown in FIG. 5.

FIG. 7 illustrates a component of the bollard lamp of FIG. 1.

FIG. 8 provides a top view of a base component of the bollard lamp.

FIG. 9 provides a perspective view of the base component.

FIG. 10 provides a perspective view of a top cap of the bollard device.

FIG. 11 provides a rear perspective view of a LED mounting assembly.

FIG. 12 provides a front perspective view of a LED mounting assembly.

FIG. 13 provides a side view of the LED mounting assembly.

### DETAILED DESCRIPTION

Described herein is technology relevant to light emitting devices, and components for light emitting devices. Embodiments are primarily described by reference to a bollard lamp. However, it will be appreciated that the technology has wider application.

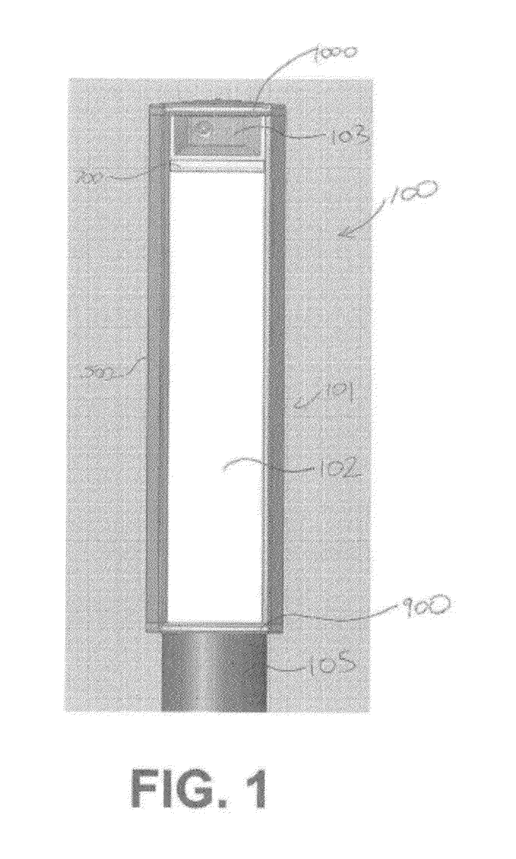

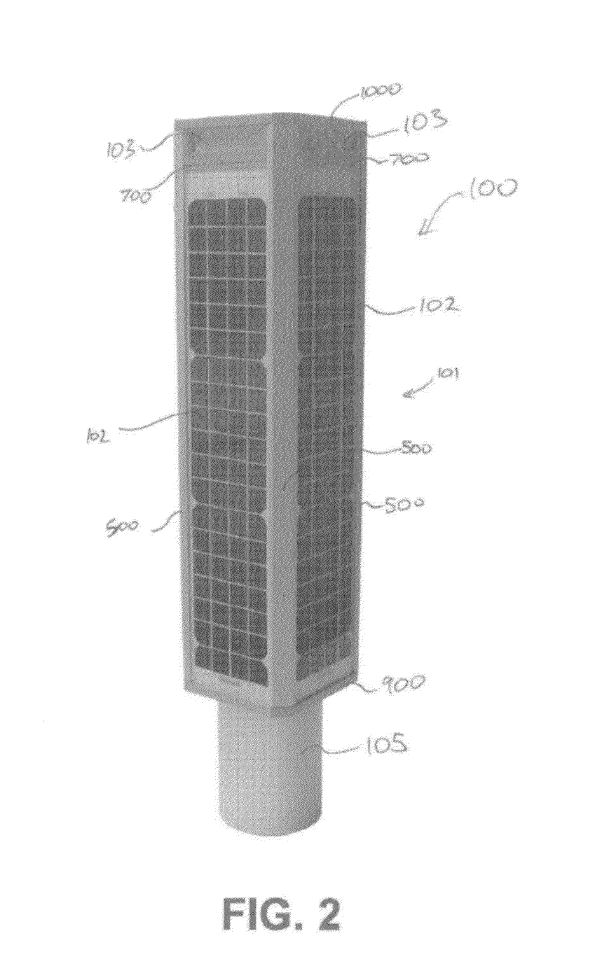

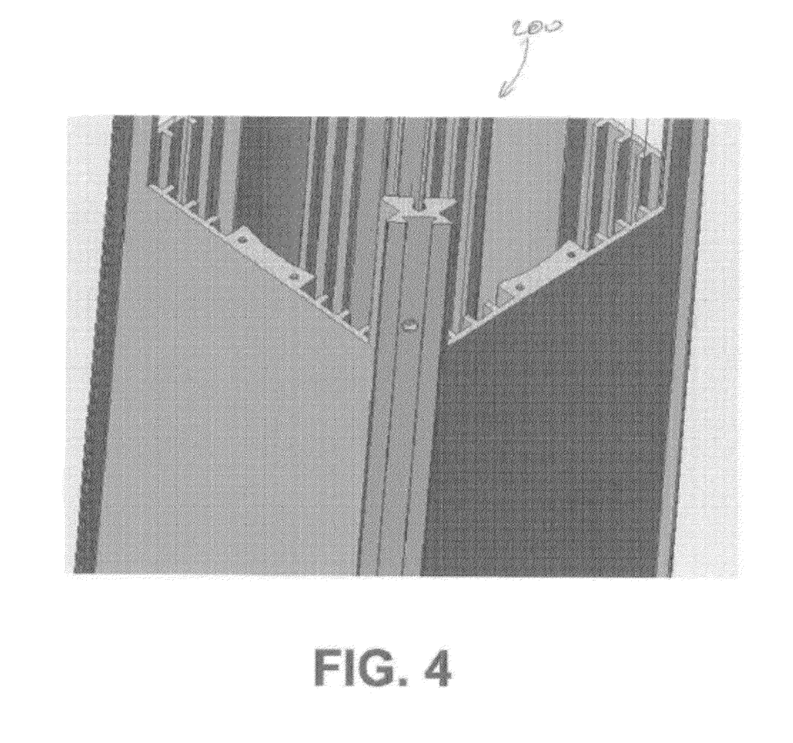

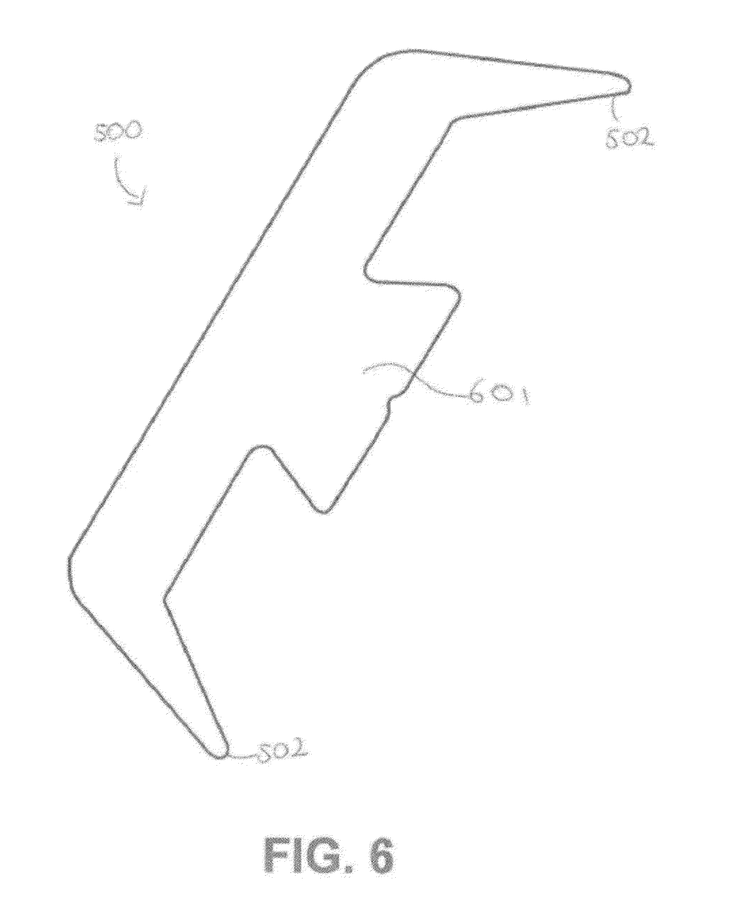

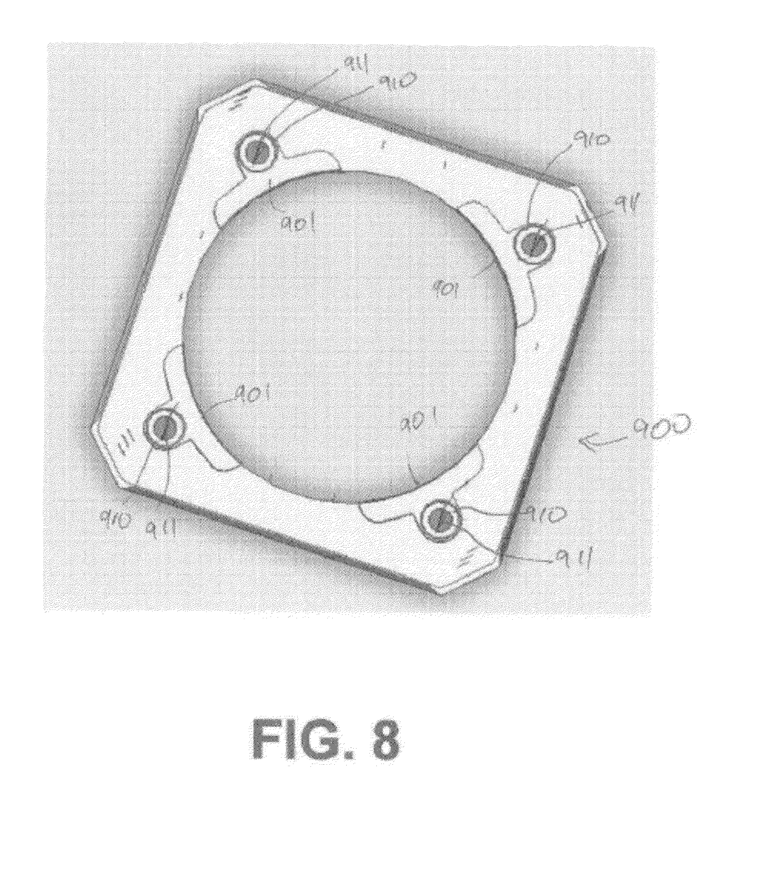

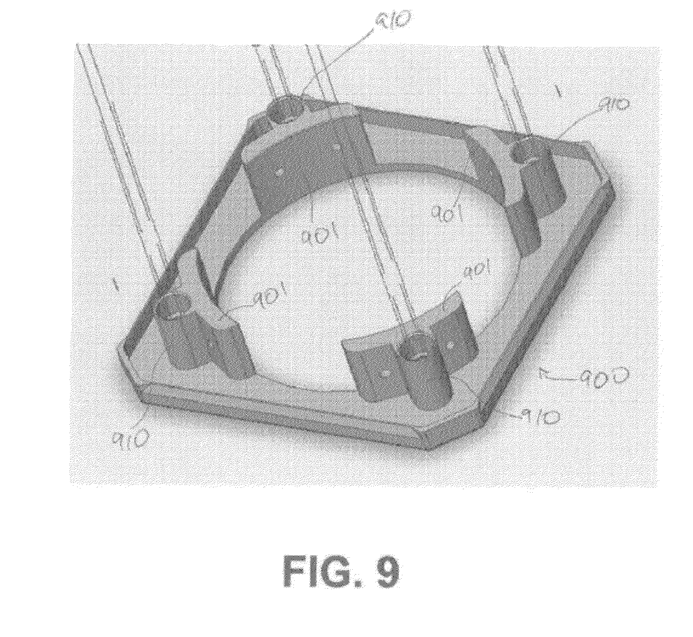

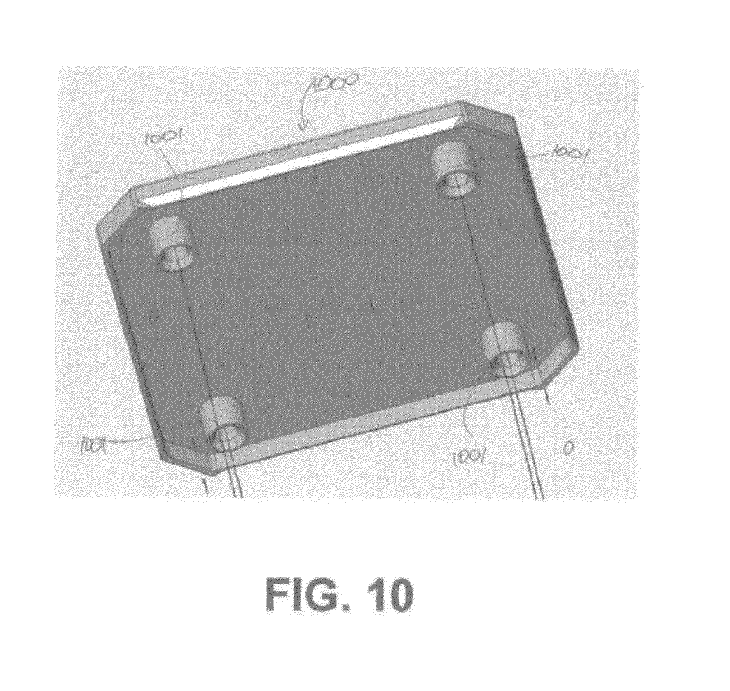

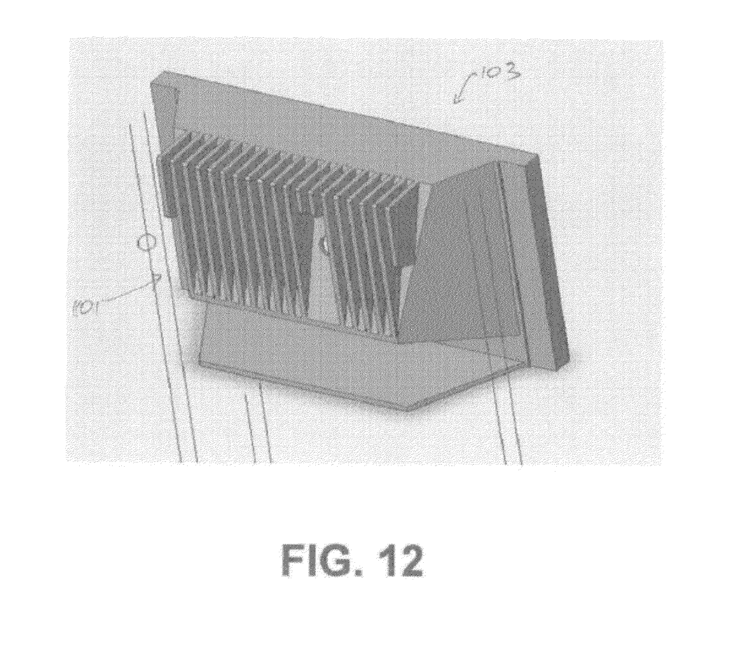

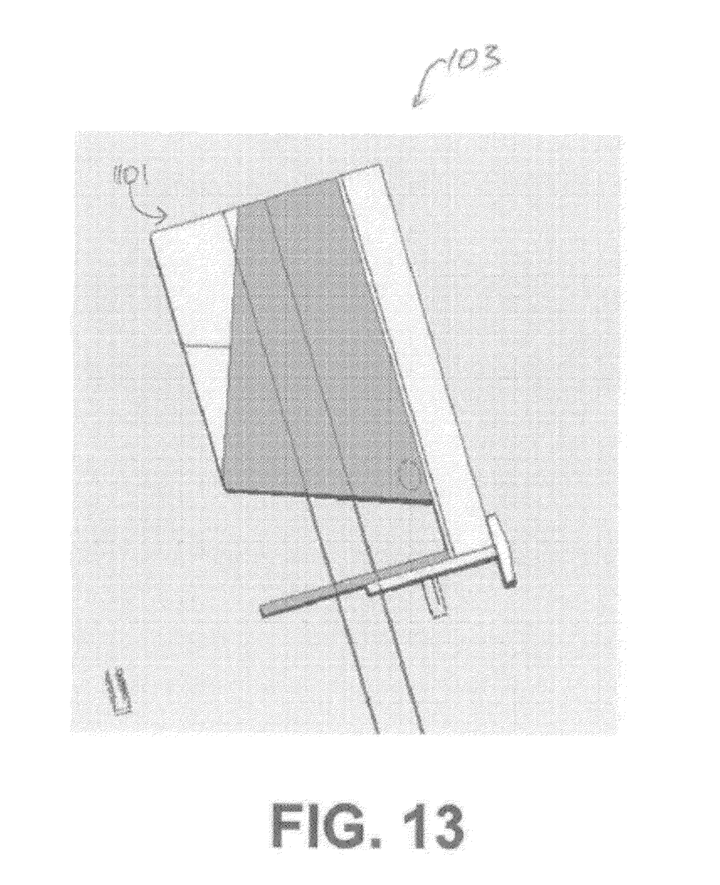

FIG. 1 to FIG. 13 illustrate a bollard lamp 100 according to one embodiment, and/or components thereof. When assembled in the manner shown in FIG. 1 and FIG. 2, lamp 100 includes a body 101 defined by a substantially quadrangular cross section. Each side of the body supports a solar panel 102 and a LED mounting formation 103. Each LED mounting formation houses one or more LED lamps, which are powered via solar panels 102 (preferably via a battery arrangement, which is not shown). Body 101 is mounted to a cylindrical ground-mounted bollard support 105, which is preferably at least partially buried into the ground.

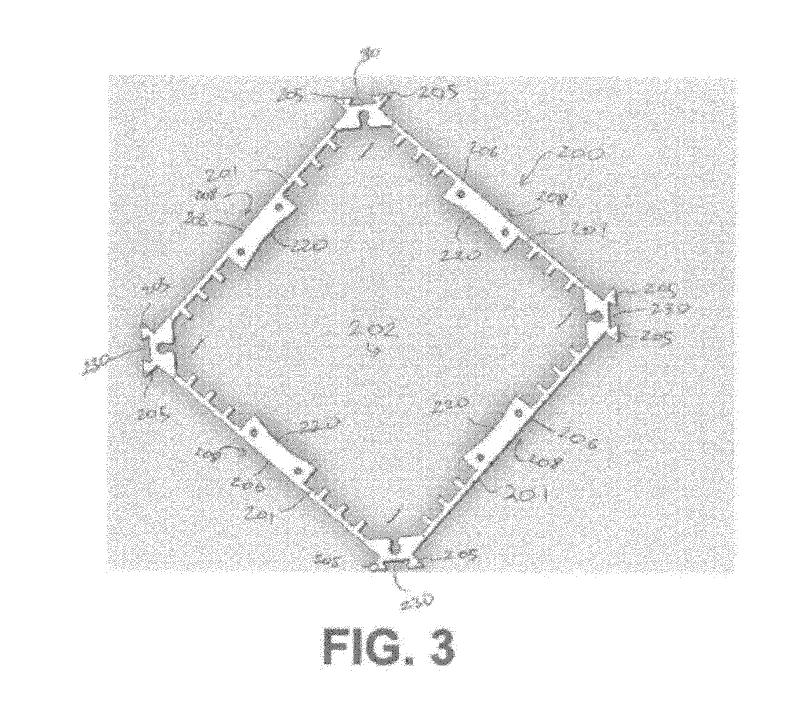

FIG. 3 illustrates a vertically extending extruded member 200 of substantially continuous cross section, which substantially defines body 101. The extruded member is preferably formed from aluminium. In the illustrated embodiment member 200 includes four sidewalls 201 collectively defining a central core 202. However, it will be appreciated that in other embodiments an alternate number of sidewalls 201 are present (being three or more).

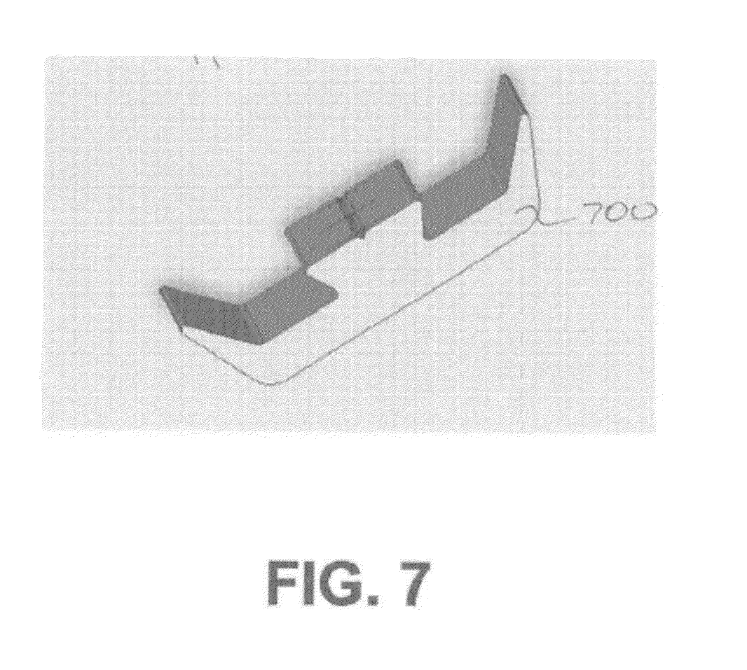

Each sidewall 201 has a pair of extending protrusions 205 along its vertically extending edges. The protrusions of a given sidewall collectively define a channel 208 bounded by inner faces of protrusions 205 and an outer face 206 of sidewall 201. The channel is configured for receiving a solar panel and a LED mounting assembly. The former is stacked above the latter, as shown in FIG. 1, separated by a spacer 700 component shown in FIG. 7. Vertical mounting of solar panels allows for large panels as compared with known devices, which include top-mounted horizontal solar panels. Furthermore, the illustrated configuration has been observed to efficiently capture light, due to the range of aspects supported by the multiple panels.

The vertically mounted of solar panels generate power for consumption by emitting components, preferably via a rechargeable battery arrangement or the like. Preferably at least 60% of each sidewall is covered by solar panel, but more preferably at least 80% of each sidewall is covered by solar panel, and still more preferably at least 90% of each sidewall is covered by solar panel. This extensive coverage of vertically elongate sidewalls leads to efficient light capturing across a range of install locations and conditions. In cases where the number of solar panels is equal to the number of sidewalls, each solar panel preferably has a vertical surface dimension of at least three times its horizontal surface dimension, or more preferably four times its horizontal surface dimension.

Each channel is additional configured to optionally support a covering member in place of the LED mounting assembly. In this manner, lamp 100 is configured to support from one to four LED mounting assemblies, depending on requirements of a specific implementation. It will be appreciated that reducing the number of LEDs, whilst retain the same number of solar panels, allows for increased power (and hence light emission) from the remaining LEDs.

The extruded member includes, at each corner defined by the connection of adjacent sidewalls, a vertically extending channel for captivity receiving a retaining member 500. The retaining member includes a pair of abutting edges 502, each being configured to abuttingly engage with a respective one of the solar panels. In the manner, each solar panel is held in place by a pair of abutting edges 502 provided by respective retaining members 502.

Each sidewall includes an inwardly facing curved abutment face 220 for abutting engagement with ground-mounted bollard support 105. Face 220 is curved to match the curvature of support 105. Furthermore, formations 221 that define faces 220 are positioned relative to corresponding formations 901 on a based member 900 thereby to define a substantially complete circle around support 105 upon assembly of light 100.

The lamp includes, along each corner edge defined by the meeting to adjacent sidewalls, a vertically extending channel 230 for captivity receiving a respective one of the retaining members. Specifically, each retaining member 500 includes a central formation 601 which is slidably received in channel 230. Each retaining member includes one or more threaded portions positioned at locations along its length for receiving threaded members that extend through respective horizontally formed apertures in the vertically extending channels, thereby to inwardly bias the retaining members. That is, by tightening the threaded members, the retaining formation is pulled tightly inwards.

Preferably the sidewalls are flat and planar, such that each solar panel's inward facing surface is substantially fully contacting with a respective sidewall. In this manner the solar panels are protected from damage, as forces applied to the panels are dissipated though the sidewalls.

The vertically-mounted solar panels 202 each have an outward-facing functional surface and an inward facing surface. The inner surfaces are positioned against or adjacent respective outer surfaces of the bollard sidewalls. A plurality of heat dissipation protrusions are formed on the inner surface of each bollard sidewall, the heat dissipation protrusions extending into the central core. These protrusions are, in the illustrated embodiment, defined by vertically extending fins that collectively define a heat sink, these being integrally formed from the sidewall as part of extruded member 200. In this manner, heat accumulating at the solar panels is efficiently dissipated via the inner surface and the heat dissipation protrusions.

Lamp 100 includes a top cap 1000 and a bottom cap (or base) 900. Upon assembly of the lamp, these sandwich the extruded member and seal the central core. That is, the top cap is in abutting engagement with respective upper edges of the plurality of sidewalls, and the bottom cap is in abutting engagement with respective lower edges of the plurality of sidewalls.

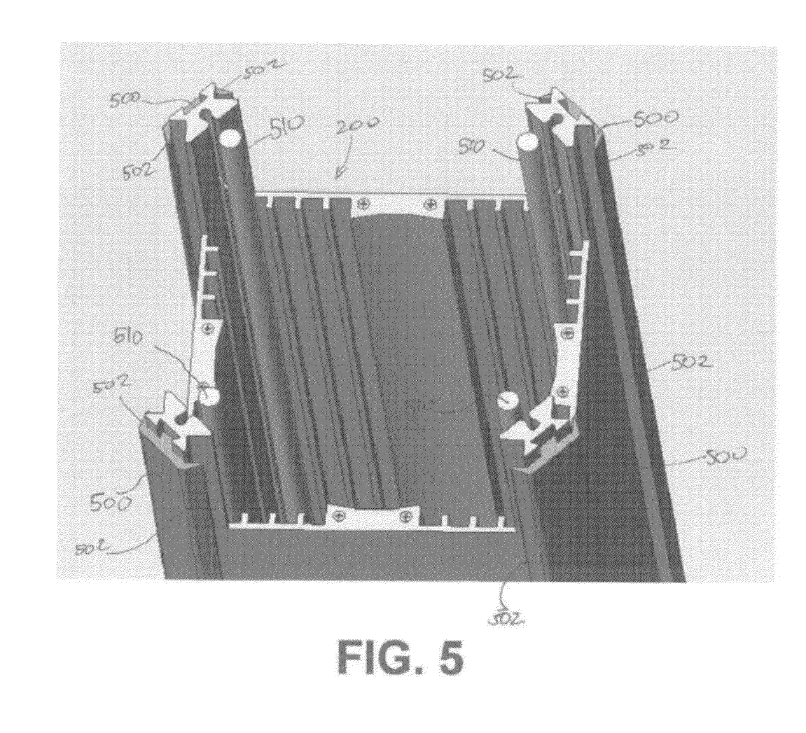

The top cap is mounted to the bottom cap by a plurality of vertically extended rods 510, as best shown in FIG. 5. These are coupled to formations 1001 in the top cap, and pass into formations 910 formed in the bottom cap. Preferably the rods are internally threaded, and screws inserted through the lower surface of the bottom cap via apertures 911, allowing tightening from beneath the bollard. This form of construction is particularly preferable for a number of reasons, including the ability to avoid a need to external mounting members in the top cap (which assists in weather resistance, and vandalism protection).

Preferably the top cap includes additional heat dissipation protrusions extend an inner surface of the top cap into the central core, thereby to dissipate heat accumulating via the top cap. These may be integrally formed with the top cap, or supported on a component underlying the top cap.

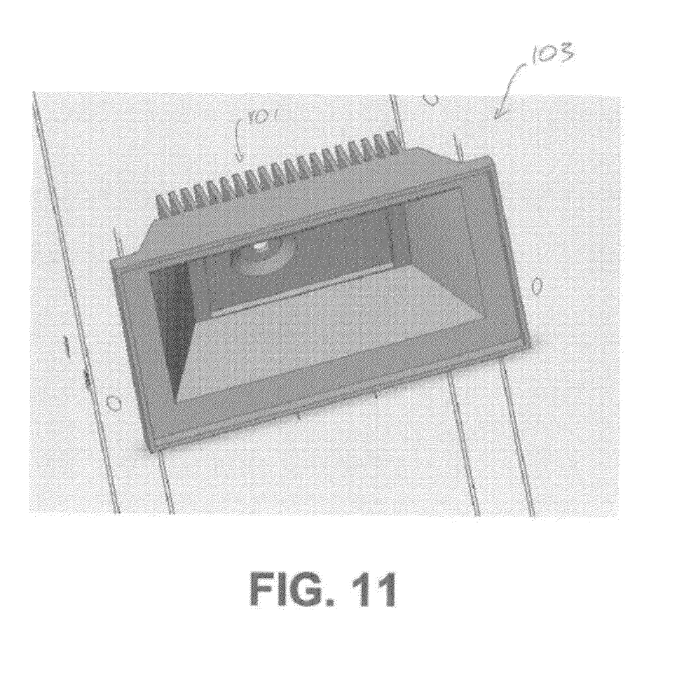

As shown in FIG. 11 to FIG. 13, each lamp mounting member is configured to support a respective one or more LED lamps, and includes backing portion 1101 positioned within the central core. Each backing portion includes a plurality of integrally formed fins 1102 thereby to dissipate heat generated by the respective one or more LED lamps.

To assemble lamp 100, support 105 is first mounted into the ground. Base 900 is then affixed to support 105, for example using screws or bolts. Member 200 is then placed on base 900. This may be preceded by, or alternately followed by, the mounting of retaining members, solar panels, spacers and light assemblies into member 200. Batteries and cables are then configured, and the battery preferably positioned within support 105 (for example below ground). Top cap 1000 is then installed, with rods 510 already affixed. This positions rods 510 into formations 910 in base 100, and these are affixed using screws via apertures 911.

It will be appreciated that the above description facilitates design and construction of novel and inventive light emitting devices, such as bollard lamp 100. The design features described herein are particularly advantageous in terms of heat dissipation (for example via the configuration of heat sink fans and the use of an extruded body), vandalism prevention (for example via the manner of final construction and the positioning of planar sidewalls against solar panels 102), and general design efficiency (for example the nature of member 200, which allows for modular design aspects).

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention.

1. A bollard light including:
a vertically extending extruded member of substantially continuous cross section;
wherein the extruded member includes at least three sidewalls collectively defining a central core;
wherein each sidewall has a pair of extending protrusions along its vertically extending edges, the protrusions of a given sidewall collectively defining a channel bounded by inner faces of the protrusions and an outer face of the sidewall, the channel being configured for receiving a solar panel and a LED mounting assembly; and
wherein each channel is additional configured to optionally support a covering member in place of the LED mounting assembly, such that when assembled the bollard light supports a number of LED mounting assemblies less than the number of sidewalls.

2. The bollard light of claim 1 wherein the extruded member includes, at each corner defined by the connection of adjacent sidewalls, a vertically extending channel for captivity receiving a retaining member, wherein the retaining member includes a pair of abutting edges, each being configured to abuttingly engage with a respective one of the solar panels, such that each solar panel is held in place by a pair of abutting edges provided by respective retaining members.

3. The bollard light of claim 1 wherein each sidewall includes an inwardly facing curved abutment face for abutting engagement with a ground-mounted bollard support.

4. The bollard light of claim 1 including a top cap and a bottom cap which, upon assembly sandwich the extruded member and seal the central core, wherein the top cap is mounted to the bottom cap by a plurality of vertically extended rods.

5. A bollard lamp including:
a base member;
a plurality of planar sidewalls extending vertically from the base, each sidewall having an outer surface and an inner surface, a central core being defined intermediate the inner surfaces;
a plurality of solar panels, each panel having an outward-facing functional surface and an inward facing surface, each inner facing surface being abuttingly engaged with a respective one of the sidewall outer surfaces;
a top cap having a plurality of rod receiving formations, wherein the top cap abuttingly engaged against respective top edges of the plurality of sidewalls, and the red receiving formations are contained within the central core;
a plurality of rods, each being mounted to at its distal and to one of the rod receiving formations and at its proximal end to the base member;
wherein the base member includes a plurality of apertures thereby to facilitate external access to one or more fixing members used to securely attach the rods to the base member.

6. The bollard lamp of claim 5 wherein each solar panels is held in abutting engagement against the outer surfaces by a pair of vertically extending retaining members.

7. The bollard lamp of claim 6 wherein along each corner edge defined by the meeting to adjacent sidewalls, a vertically extending channel for captivity receiving a respective one of the retaining members.

8. The bollard lamp of claim 7 wherein each retaining member includes one or more threaded portions for receiving threaded members that extend through respective horizontally formed apertures in the vertically extending channels, thereby to inwardly bias the retaining members.

9. A bollard light including:
a plurality of vertically-mounted solar panels, each panel having an outward-facing functional surface and an inward facing surface;
for each solar panel, a bollard sidewall having an outer surface and an inner surface, wherein the outer surface of the bollard sidewall is positioned adjacent the inward facing surface of the solar panel;
a plurality of heat dissipation protrusions formed on the inner surface of each bollard sidewall, the heat dissipation protrusions extending into a central core defined by space between the sidewalls, such that heat accumulating at the solar panels is dissipated via the inner surface and the heat dissipation protrusions.

10. The bollard light of claim 9 wherein the plurality of heat dissipation protrusions are vertically extending fins that collectively define a heat sink.

11. The bollard light of claim 9 wherein, for each sidewall, the heat dissipation protrusions are integrally formed from the sidewall.

12. The bollard light of claim 9 further including comprising a top cap in abutting engagement with respective upper edges of the plurality of sidewalls, wherein additional heat dissipation protrusions extend an inner surface of the top cap into the central core, thereby to dissipate heat accumulating via the top cap.

13. The bollard light of claim 9 including a plurality of light mounting members configured to support a respective one or more LED lights, wherein each light mounting member includes a backing portion positioned within the central core, wherein each backing portion includes a plurality of integrally formed fins thereby to dissipate heat generated by the respective one or more LED lights.

14. The bollard light of claim 9 comprising:
a substantially prismatic body having a base, a top, and three or more vertically extending elongate sidewalls extending between the base and the top;
at least one light emitting component supported by the body; and
a plurality of solar panels supported by the body, wherein the plurality of solar panels generate power for consumption by the at least one light emitting component, and wherein at least 60% of each sidewall is covered by solar panel.

15. The bollard light of claim 14 wherein at least 80% of each sidewall is covered by solar panel.

16. The bollard light of claim 14 wherein at least 90% of each sidewall is covered by solar panel.

17. The bollard light of claim 14 wherein the number of solar panels is equal to the number of sidewalls.

18. The bollard light of claim 17 wherein each solar panel has a vertical surface dimension of at least three times its horizontal surface dimension.

19. The bollard light of claim 17 wherein each solar panel has a vertical surface dimension of at least four times its horizontal surface dimension.
